(19) United States
(12) Patent Application Publication
(10) Pub. No.: US 2002/0138392 A1
(43) Pub. Date: Sep. 26, 2002

(54) Network based system for real-time trading of physical commodities

(76) Inventor: Donald G. LeBlanc, Fredericton (CA)

Correspondence Address: Law Office - Dinesh Agarwal, P.C., Suite 330, 5350 Shawnee Road, Alexandria, VA, 22312, US

(21) Appl. No.: 09/749,605

(22) Filed: Dec. 28, 2000

(51) Int. Cl. G06F 17/60

(52) U.S. Cl. 705/37

(57) ABSTRACT

A network-based system for the real-time trading of physical commodities requiring shipment from a supplier to the buyer. The system comprises a central server connected to a number of user stations over a wide area network such as the Internet and World Wide Web. Trading boards containing posted offers to sell a physical commodity by suppliers are downloaded over the network to the user stations. Each trading board represents a specific physical commodity and each trading board is referenced to a trading zone. Each trading zone comprises a defined geographical area in which potential suppliers compete and potential buyers post bids to the posted offers. A freight rate adder mechanism is provided to adjust the posted offers to reflect the price of shipping the physical commodity to the trading zone associated with the trading board, and to adjust the posted bids to reflect the price of shipping the physical commodity to the buyer's destination.

### FIELD OF THE INVENTION

The present invention relates to a computer method and system for real-time trading of physical commodities, and more particularly, to a method and computer system for real-time trading of lumber over the Internet.

### BACKGROUND OF THE INVENTION

The Internet comprises a vast number of computers and computer networks that are interconnected through communication links. The interconnected computers exchange information using various services, such as electronic mail, and the World Wide Web or WWW. The World Wide Web allows a server computer system, i.e. a Web server or a Web site, to send graphical Web pages of information to a remote client computer system. The remote client computer system can then display the Web pages of information to a remote client computer system. The remote client computer system can then display the Web pages on its monitor screen. Each resource on the Web, e.g. computer or Web page, is uniquely identifiable by a Uniform Resource Locator or URL. To view a specific Web page, a client computer system specifies the URL for that Web page in a request, for example, a HyperText Transfer Protocol or HTTP request. The request is forwarded to the Web server that supports that Web page. When that Web server receives the request, it sends that Web page to the client computer system. When the client computer system receives that Web page, it typically displays the Web page using a browser. A browser is a special purpose computer application program that allows a user to request Web pages and display the Web pages. Most of today's Internet browsers are JAVA™ language compatible and enabled to execute JAVA™ applets, which are module of computer code that are executed as part of Web pages downloaded from the Internet.

The World Wide Web is especially conducive to conducting electronic commerce or “e-commerce”. Many Web servers have been developed through which vendors can advertise and sell products. Popular e-commerce enterprises include selling music delivered through electronically over the Internet and selling books that are delivered through conventional distribution channels, e.g. common carriers. Over the last few years e-commerce on the Internet has rapidly expanded to encompass many different types of enterprises including the trading of physical commodities.

With the advent of the Internet and, particularly, the World Wide Web, known electronic trading interfaces for the Web have all generally evolved in one form or another from the well-known bulletin board model. The bulletin board model can take the form of a ‘straight auction’ board or a ‘make me an offer’ board. For the straight auction board model, product offerings are posted on one or more auction boards and buyers submit bids. The auction board essentially comprises an electronic bulletin board with a list of postings from sellers. Potential buyers submit offers through the application program for the bulletin board or via e-mail, and then at the end of a predetermined or published time period, the buyer with the highest submitted offer wins the bid. For the make me an offer board model, the product offerings, i.e. postings from sellers, are posted together with the seller's asking price on an electronic bulletin board. The potential buyers post their offers and the offers, and any other buyer requirements, are matched with the sellers' asking prices.

The dot.com trading sites compete with the traditional commodity trading establishments. In a traditional “bricks and mortar” model, the commodities trading business is conducted on a real-time or quasi real-time basis via phone, facsimile, and/or e-mail communications. Traditional commodity trading involves dealing with constant pricing gyrations and as a result pricing is evaluated on a continuous basis using phone/fax/email communications between sellers and potential customers. The problem facing traditional commodity traders and buyers is efficiency. Typically, traders will need to contact a large pool of competing traders and buyers in order to have a feel for what is the “going price”. It is not uncommon for a trader to make a 100 calls and have 10 conversations to make one trade of a commodity product. Commercial efficiency is further hampered by the practice of counter-offers and bluffing as a prelude to actually discussing and concluding the transaction.

The systems based on the electronic bulletin board model for trading physical commodities generally follow a sequence of steps to effect a transaction which take the following form: (1) first, a producer or seller posts a product offering to the bulletin board; (2) potential buyers view the bulletin board and the postings and decide whether to submit an offer on the posted product offering; (3) the potential buyer(s) post their offer; (4) the seller reviews the posted offers by the potential buyers and decides whether to accept any of the offers; (5) the seller posts its acceptance of one of the offers; (6) the potential buyer with the accepted offer is notified; (7) the potential buyer responds to the seller to complete to the transaction. It typically takes at least an hour or more for the seller and successful buyer to conclude the transaction. This time delay is mainly a result of the asynchronous nature of postings on the bulletin board.

Any attempt to adapt the electronic bulletin board model to commodities trading must provide real-time operation for commercial efficacy. While the electronic bulletin model provides an electronic platform which is operable for commodity type trading, the architecture of the electronic bulletin board model does not provide the most efficient electronic model for commodity trading on an electronic platform.

A further consideration associated with the trading of physical commodities is the requirement of delivery. Physical commodities require delivery. In practical terms, this means that because of transportation costs suppliers or sellers of physical commodities are limited to geographic areas and markets where they can be competitive. For buyers transportation costs are also an important consideration. Buyers will only want to buy commodity products which are priced competitively on a delivered basis. As a result, transportation costs are an important factor for both buyers and sellers in the trading of physical commodities.

Accordingly, there remains a need for an electronic platform which provides for commercial efficiency and real-time trading for commodity type products and also accounts for transportation costs from both the sellers and the buyers points of view.

### BRIEF SUMMARY OF THE INVENTION

The present invention addresses these shortcomings and need by providing a computer method and system for real-time trading of physical commodities.

The system comprises a central server and a number of user computers connected through a network. The system provides a series of trading boards associated with zones based on geographic centers of trading activity. Each trading board represents a specific commodity product referenced to a geographic zone or market area. The zone represents a geographic or market area in which suppliers can deliver product on a competitive basis.

Users, i.e. sellers or buyers, utilize an Internet browser program with JAVA™ capability to access the central server over the network or Internet. The central server downloads trading board views to the user computers. The trading board views display real-time postings and information. The trading board views are also modifiable based on the user's unique profile and attributes.

The postings are modified according to a zone-based determination to account for transportation/freight factors. Users can post bids or asks, or accept a posted bid or ask, from their computers based on their assigned trading privileges. The acceptance of a posted bid or ask concludes a transaction.

According to another aspect, transactions on the basis of delivered prices. To prevent any supplier from gaining an advantage, trading board pricing is based on the commodity product delivered to the zone for that trading board regardless of the origin of the supplier, and the suppliers bid on a trading board zone with transportation costs included in their prices. However, buyers are generally not interested in delivered prices to the trading zone (unless of course the buyer is located in the geographic center of the trading zone). Buyers are interested in the delivered price to their address destinations. Therefore to protect competing suppliers from being distinguished by buyers on the basis of differences in their freight charges, the system includes a freight rate adder mechanism to account for the differences between ‘trading zone’ and ‘delivered’ prices.

In one aspect, the present invention provides a network-based system for trading physical commodities in real-time, said system comprising: (a) a server coupled to a network; (b) said network including a plurality of ports for coupling user stations to said network for communicating with said server; (c) said server including a component for generating a trading board, said trading board comprising posted offers for a physical commodity and said trading board being referenced to a trading zone, and said server including a component for sending said trading board to one or more of said user stations coupled to said network; (d) said user stations including a display component for displaying said trading board, and further including a component for accepting a posted offer on said trading board and communicated said acceptance to said server.

In another aspect, the present invention provides a network-based system for trading physical commodities in real-time, said system comprising: (a) a server coupled to a network; (b) said network including a plurality of ports for coupling user stations to said network for communicating with said server; (c) said server including a component for generating a trading board, said trading board comprising posted offers for a physical commodity and said trading board being referenced to a trading zone, wherein said trading zone comprises a geographic area having one or more suppliers of the physical commodity and one or more potential buyers of said physical commodity, and said server including a component for sending said trading board to one or more of said user stations coupled to said network; (d) said user stations including a component for posting a bid for a physical commodity being offered on said trading board; (e) said user stations including a display component for displaying said trading boards, and further including a component for accepting a posted offer on said trading board and communicating said acceptance to said server.

In yet another aspect, the present invention provides a computer data signal embodied in a carrier wave, said carrier wave comprising: (a) a trading board view code segment; and (b) said trading board view code segment comprising a plurality of posted offer code segments and plurality of posted bid code segments and a trade zone code segment, said trading board view segment defining a trading board view referenced a trading zone defined by said trade zone code segment, and wherein said trading zone corresponds to a geographic area.

Other aspects and features of the present invention will become apparent to those ordinarily skilled in the art upon review of the following description of specific embodiments of the invention in conjunction with the accompanying drawings.

### BRIEF DESCRIPTION OF THE DRAWINGS

Reference will now be made to the accompanying drawings, which show, by way of example, a preferred embodiment of the present invention, and in which:

FIG. 1 shows in schematic form a network and computer system for conducting commercial transactions electronically;

FIG. 2(a) shows in diagrammatic form a Trading Board Search screen according to the present invention;

FIG. 2(b) shows in diagrammatic form a Trading Board Listing screen according to the present invention;

FIG. 3 shows in diagrammatic form a Static HTML Trading Board screen according to the present invention;

FIG. 4(a) shows in diagrammatic form a Transaction Summary screen in accordance with the present invention;

FIG. 4(b) shows in diagrammatic form a Transaction Confirmation screen in accordance with the present invention;

FIG. 5(a) shows in diagrammatic form a Post Ask 1 screen in accordance with the present invention;

FIG. 5(b) shows in diagrammatic form a Post Ask 2 screen in accordance with the present invention;

FIG. 5(c) shows in diagrammatic form a Post Ask Confirmation screen in accordance with the present invention;

FIG. 6(a) shows in diagrammatic form a Post Bid 1 screen in accordance with the present invention;

FIG. 6(b) shows in diagrammatic form a Post Bid 2 screen in accordance with the present invention;

FIG. 6(c) shows in diagrammatic form a Post Bid Confirmation screen in accordance with the present invention;

FIG. 7 shows in diagrammatic form a Real Time Trading Board screen in accordance with the present invention;

FIG. 8 shows in diagrammatic form a Postings screen in accordance with the present invention;

FIG. 9(a) shows in diagrammatic form a Modify Posting 1 screen in accordance with the present invention;

FIG. 9(b) shows in diagrammatic form a Modify Posting 2 screen in accordance with the present invention; and

FIG. 10 shows in diagrammatic form a Favorites screen in accordance with the present invention;

FIG. 11 shows in diagrammatic form a Graphs screen in accordance with the present invention;

FIG. 12 shows in flowchart form a method for concluding two simultaneous transactions; and

FIG. 13 shows in diagrammatic form a mechanism for calculating freight rate according to another aspect of the invention.

### DETAILED DESCRIPTION OF THE PREFERRED EMBODIMENT

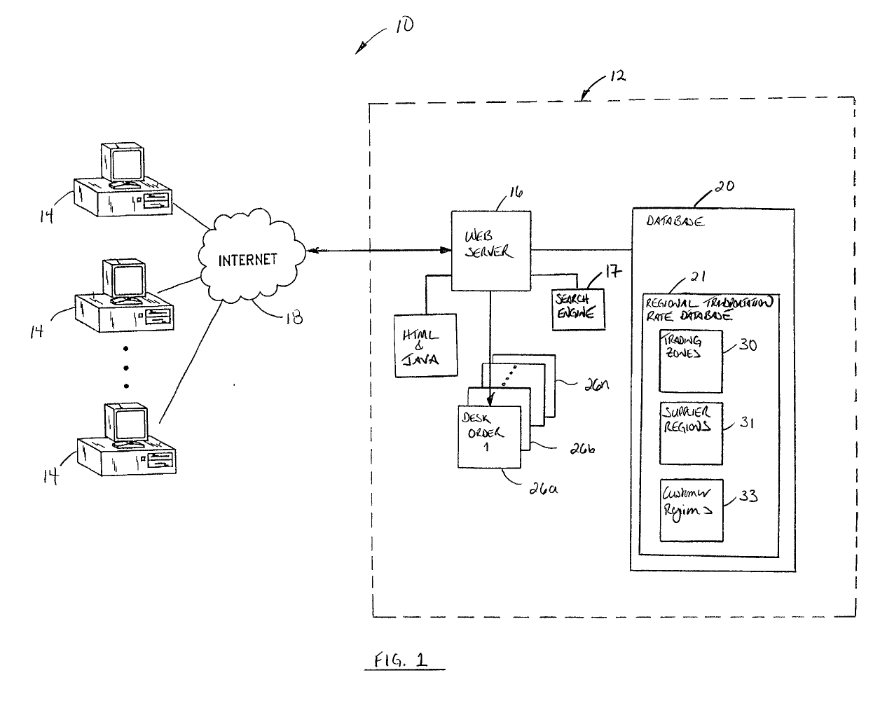

Reference is first made to FIG. 1, which shows in schematic form a network based real-time commodity trading system indicated generally by reference 10. While the real-time commodity trading system 10 is described in the context of lumber products, it is to be understood that the system 10 has wider applicability to other commodity products, and the following description using lumber products as the physical commodity is merely illustrative.

In the preferred embodiment, the real-time commodity trading system 10 comprises an Internet or Web-based implementation. It will however be appreciated that other network topologies, such as an Intranet, wide area networks, may be utilized. As shown in FIG. 1, the Web-based implementation of the real-time commodity trading system 10 comprises a real-time commodity trading web site 12 and a number of user computers 14. The web site 12 comprises a web server application or web server indicated by reference 16. The user computers 14 communicate with the web server 16 via the Internet 18.

As shown in FIG. 1, in addition to the web server 16, the web site 12 also includes a database 20. As will be described in further detail below, the database 20 comprises a regional transportation rate database indicated by reference 21. The regional transportation rate database is organized into Trading Zones 30, Supplier Regions 31, and Customer Regions 32, as will also be described in more detail below. The web site 12 also includes a search engine 17 to permit any of the users 14 to search information at the web site 12.

Each user computer 14, i.e. buyer or seller of the physical commodity, comprises a personal computer having a display monitor, a keyboard, a pointing device (e.g. a mouse), and a CPU. The computer includes memory for storing and running an application program. In the preferred embodiment, the application program is implemented in the JAVA™ programming language which are implemented or executed with an Internet browser program, such as the Netscape™ browser program or Microsoft's Internet Explorer™ browser program.

As will be described in further detail below, the web server 12 provides the users 12 with trading board views. Each of the users 14 can post bids or asks, based upon their assigned trading privileges, or users can accept a posted bid or ask, to transact a trade for a physical commodity over the Internet 18.

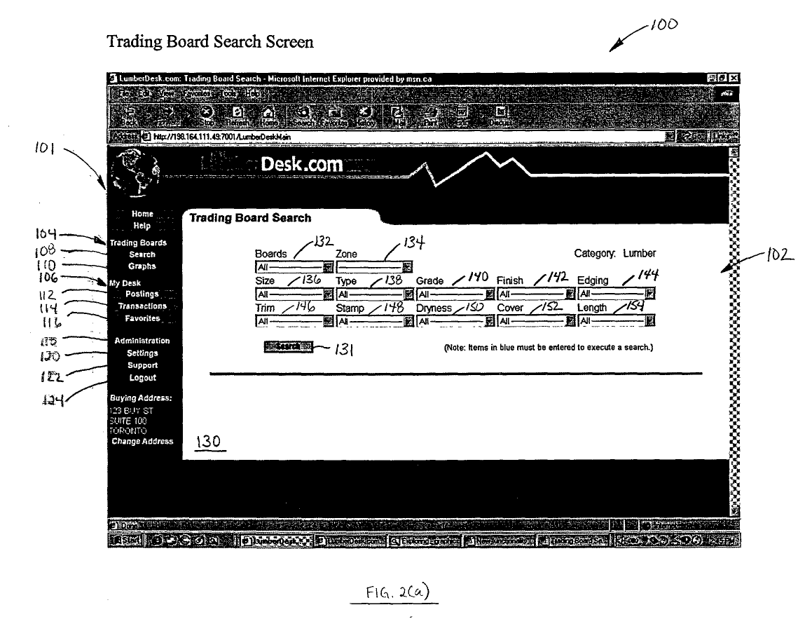

Reference is next made to FIGS. 2 through 13, which in conjunction with the following description illustrates the apparatus and methods embodied in the system 10 of FIG. 1 for trading commodities on an electronic platform suitable for the Internet 18, and in particular the World Wide Web or “the web”.

Reference is next made to FIG. 2(a), which shows in diagrammatic form a Trading Board Search screen indicated generally by reference 100. The Trading Board Search screen 100 comprises a GUI (Graphical User Interface) overlay or template 101 and an active view window 102. To facilitate user interaction, the GUI overlay 101 is common to most screens as will be described below. As shown in FIG. 2(a), the overlay or template 102 comprises a number of objects which include a Trading Boards panel 104, and a My Desk panel 106.

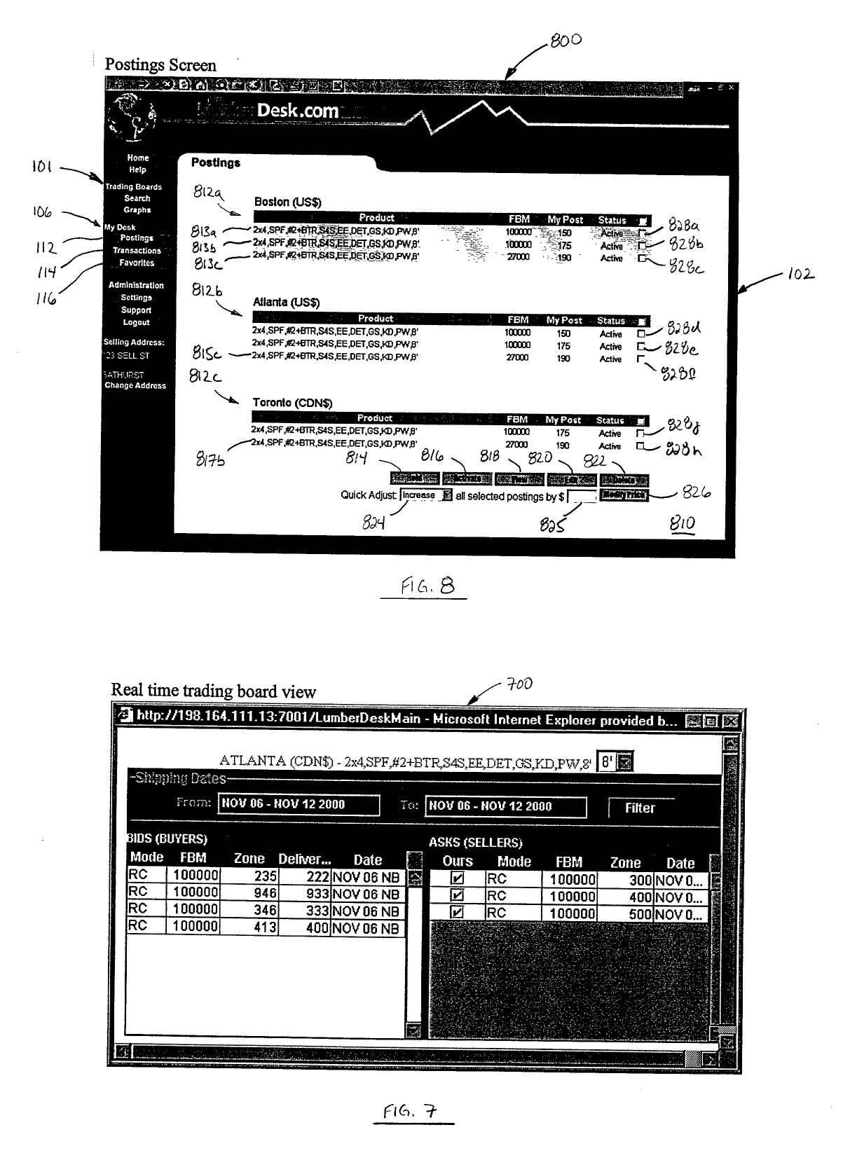

The My Desk panel 106 comprises a number of objects that allow the user to perform user-defined functions. These objects include a Postings button 112, a Transactions button 114, a Favourites button 116, an Administration button 118, a Settings button 120, a Support button 122, and a Logout button 124. Clicking on any of these objects results in a view or a new screen being displayed, for example, clicking on the Favourites button 116 results in a Favourites screen as shown in FIG. 9 being displayed.

The Trading Boards panel 103 comprises a number of objects that allow the user to access trading information from the web server 16. The Trading Boards panel 103 includes a Search button 108, and a Graphs button 110.

To enable login and access to the system 10, new users register with the administrator of the web site 12 to obtain a user name and a password. Once the user is logged into the web server 16, the Search 108 and Graphs 110 buttons are enabled. Clicking on the Search button 108 causes a Trading Board Screen view 130 to be displayed in the active view window 102 as shown in FIG. 2(a).

As shown in FIG. 2(a), the Trading Board Screen view 130 comprises a number of objects that allow the user to search the trading boards in the system 10. (The system 10, as described above, includes a search engine 17.) The Trading Board Screen view 130 includes Boards object 132 and a Zone object 134. The Boards object 132 is used to tell the search engine 17 in the system 10 what kinds of boards the user wishes to search. The user is given the option of specifying “Active” or “All” in the Boards object 132. The “Active” label indicates trading boards that have a current “bid” or “ask” posted on them, and the “All” label indicates trading boards which are both Active and Inactive, where an Inactive board is a board which at one time or another had active bid/ask postings. The Zone object 134 is used to specify the geographic trading area specified in the search. Preferably, the trading areas are predefined, for example by the website administrator for the system 10, and appear as a drop-down list box in the Zone object 134. As also shown in FIG. 2(a), the objects include product description parameters comprising a Size field 136, a Type field 138, a Grade field 140, a Finish field 142, an Edging field 144, a Trim field 146, a Stamp field 148, a Dryness field 150, a Cover field 152, and a Length field 154. The product description parameters have a default value of “All”. It will be appreciated that the product description parameters are specific to lumber and would be tailored to whatever commodity type is being offered. Once the user has populated the fields for the objects, the user clicks a Search object 131 to transmit the entered parameters to the system 10 and initiate the search through the search engine 17. Based on the information retrieved by the search engine 17, the system 10 returns a Search Results view which displayed in a Trading Board Listing screen as will be described below with reference to FIG. 2(b).

Reference is next made to FIG. 2(b), which shows in diagrammatic form a Trading Board Listing screen indicated generally by reference 200. The Trading Board Listing screen 200 includes the GUI overlay or template 101, the active view window 102, the Trading Boards panel 103, and the My Desk panel 104 as described above. In response to the search request specified by the user, the system 10 returns a Search Results active view 210. The Search Results view 210 as shown in FIG. 2(b) displays a list of products in the trading zone corresponding to the search parameters that were specified by the user in the Trading Board Search screen 50 (FIG. 2(a)).

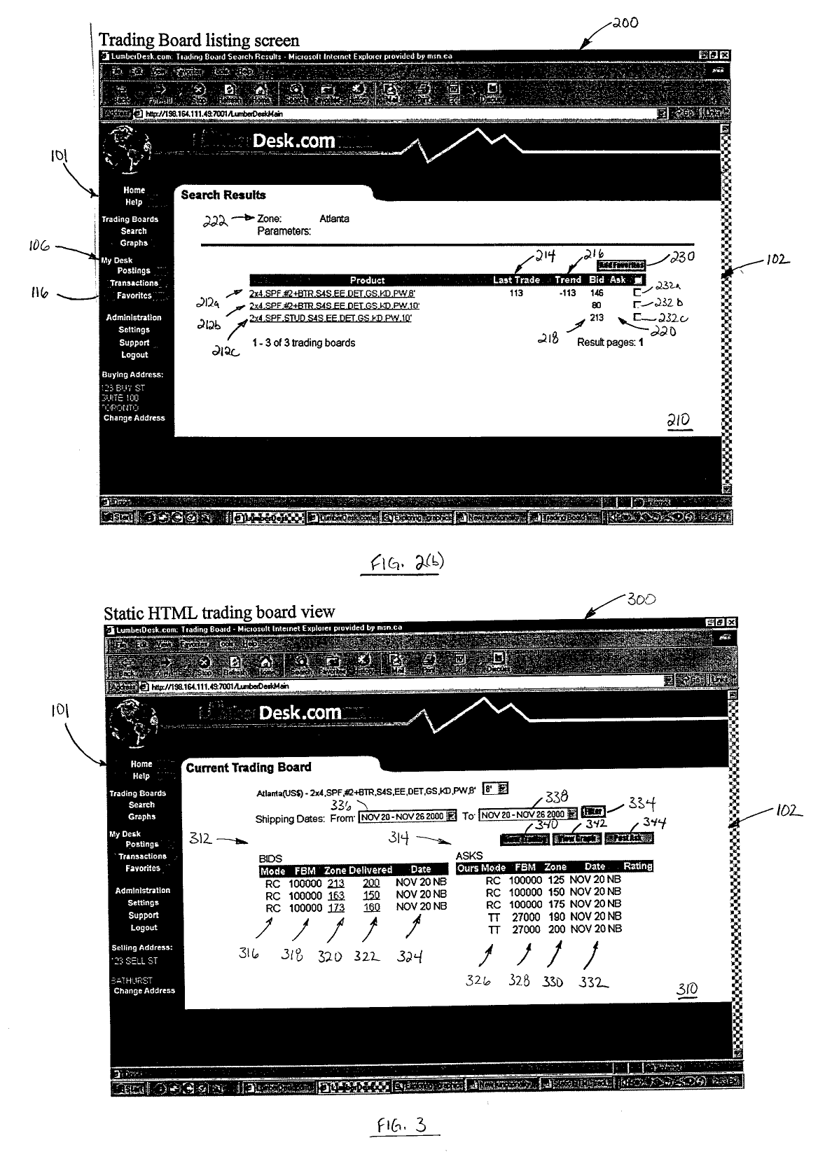

As shown in FIG. 2(b), each product returned in the Search Results view 210 comprises an object 212, indicated individually by references 212a, 212b, and 212c. Each product object 212 represents a trading board for that product, and the product object 212 is presented as an HTML (Hyper Text Markup Language) object. Clicking on the product object 212 causes the system 10 to display an HTML Trading Board view for the product as will be described in more detail below with reference to FIG. 3 below.

Referring to FIG. 2(b), the Search Results view 210 also provides additional information for each returned product object 212 and this information includes a Last Trade column 214, a Trend column 216, a Bid column 218, and an Ask column 220. The Search Results view 210 also includes an object 222 which specifies the trading zone. It will be appreciated that the trading boards are based on geographic zones as described. If the user had selected “All” in the Trading Board Search view 130, then the user can tell which of the listed products 212 is active trading board by referring to the Bid column 218 and the Ask column 220. An entry, i.e. price, in either of the Bid 218 or the Ask 220 columns indicates that the associated product 212 comprises an active Trading Board view, and clicking on the product object 212 invokes the HTML Trading Board view for that product. On the other hand, if a price is not displayed under either the Bid 218 or the Ask 220 column, the user knows that the product 212 does not have any current trading activity.

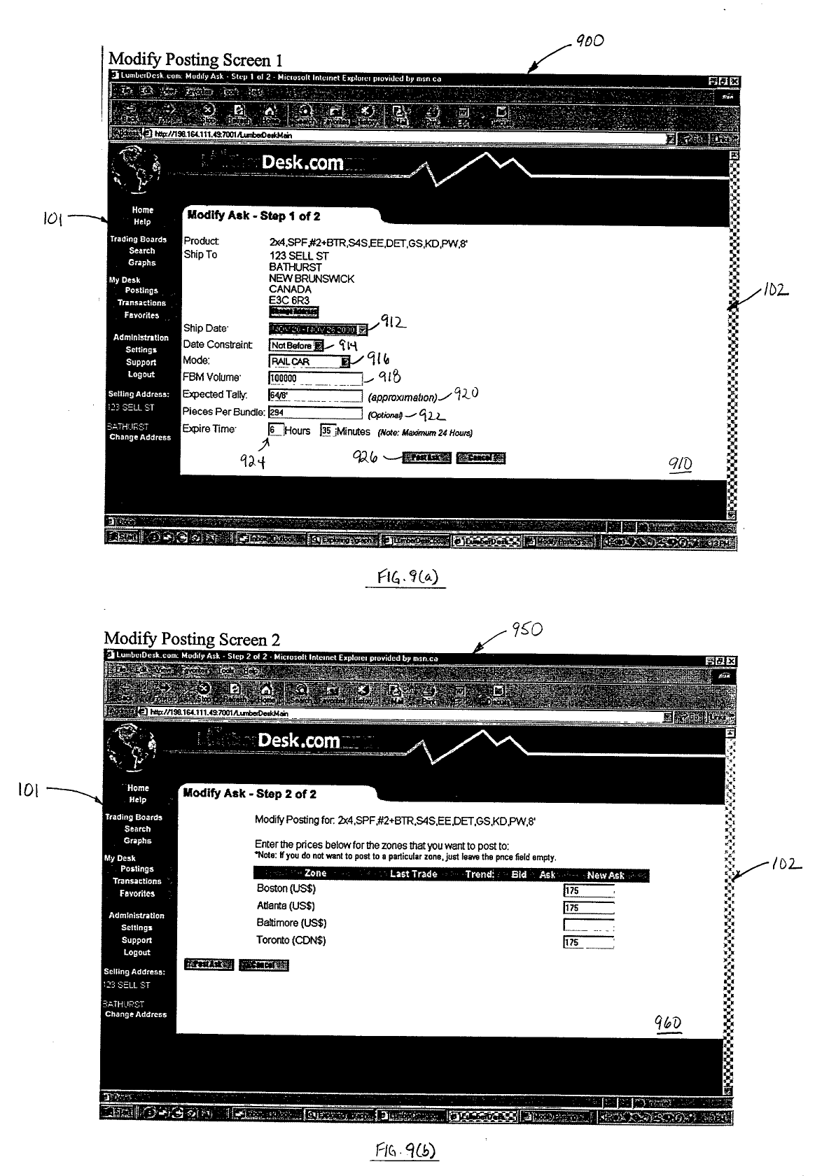

As shown in FIG. 2(b), the Trading Board Listing screen 200 also includes an Add Favorites button 230. The Add Favorites button 230 enables the user to select any or all of the products 212 and the selected products to a Favorites screen 1000 (FIG. 10). The user clicks a check box 232 next to the desired product object 212 and clicks the Favorites button 230 to add the product associated with the object 212 to the Favorites screen 1000 as shown in FIG. 10. The user accesses the Favorites screen 1000 (FIG. 10) by clicking the Favorites button 116 under the My Desk panel 106.

Reference is next made to FIG. 3, which shows a Static HTML Trading Board screen 300. An HTML Trading Board screen 300 is associated with each of the active product objects 212 presented in the Trading Board Listing screen 200 (FIG. 2(b)). The HTML Trading Board screen 300 includes the GUI overlay or template 101, the active view window 102, the Trading Boards panel 103, and the My Desk panel 104 as described above. In response to the HTML object for the product 212 being clicked by the user, the system 10 returns a Current Trading Board view 310 for that product 212. The Current Trading Board view 310 displays all of the active “bids” and all of the active “asks” for the selected product 212. The system 10, i.e. web server 16, periodically updates or refreshes the Current Trading Board view 310.

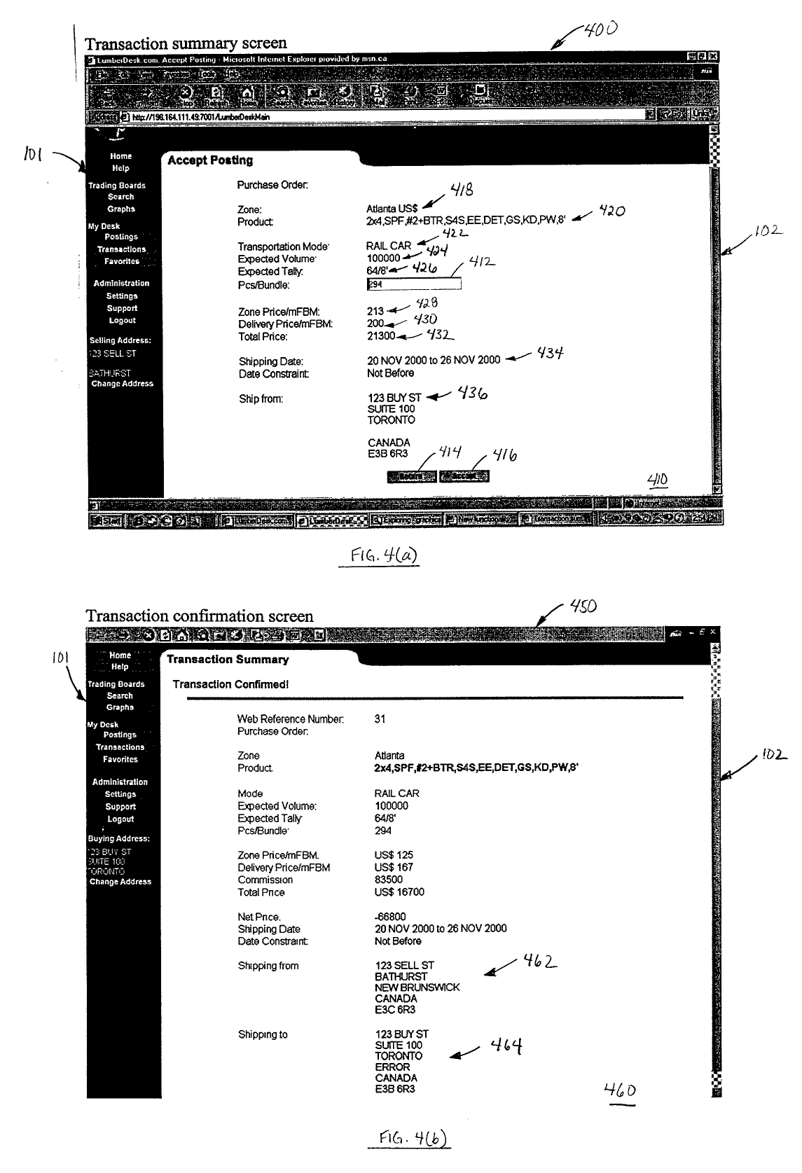

The Current Trading Board view 310 as shown in FIG. 2(b) includes an active Bids listing 312 and an active Asks listing 314. As shown, the Bids listing 312 includes columns for displaying information associated with each of the bids. The columns include a Mode column 316, a FBM column 318, a Zone delivered price column 320, a Delivered price column 322, and a delivery Date column 324. Similarly, the Asks listing 314 includes columns for displaying information associated with each of the asks, and those columns include a Mode column 326, a FBM column 328, a Zone delivered price column 330, and a delivery Date column 330. As shown in FIG. 3, the prices under the Zone price 320 and the Delivered price 322 columns for the Bids listing 312 are presented as HTML objects. Clicking on any of the HTML price objects causes the system 10 to display a Transaction Summary screen (FIG. 4(a)) with an Accept Posting view for accepting the bid as described in more detail below. The prices under the delivered Zone column 330 for the Asks listing 314 may similarly be presented as HTML objects. It will be appreciated that the state of the prices, i.e. presented as HTML objects, in the Bids listing 312 or in the Asks listing 314 depends on whether the user is logged into the system 10 as a “buyer” or as a “seller”. For example, the Bids listing 312 is displayed with active HTML price objects under the columns 320 and 322, when the user is logged in as a buyer.

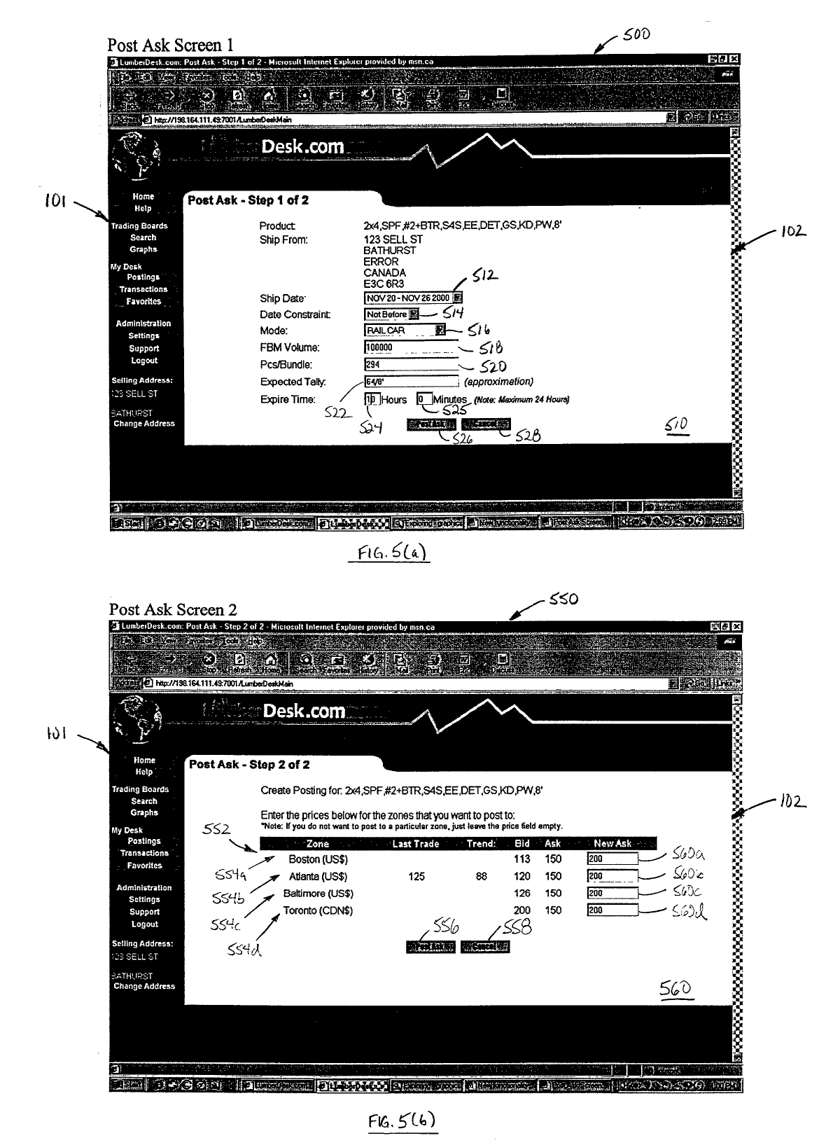

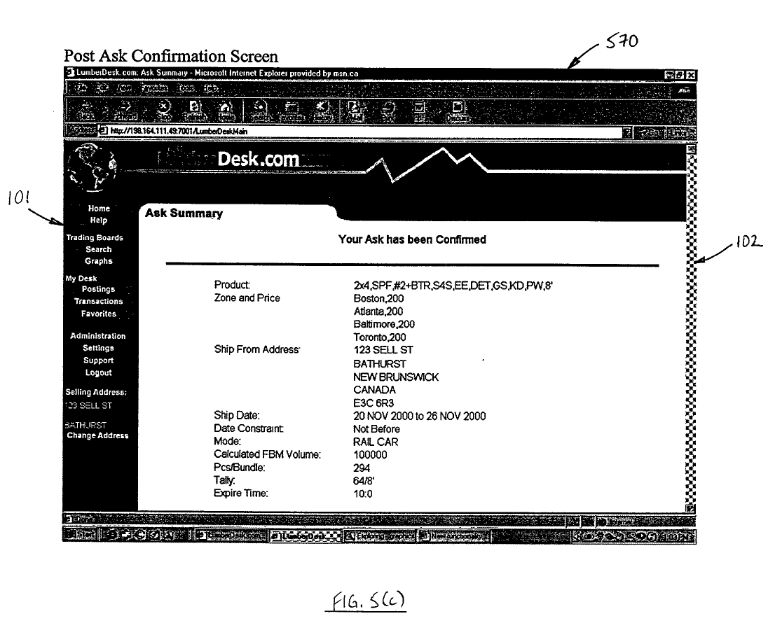

Referring again to FIG. 3, the Current Trading Board view 310 also includes a Filter button 334 for filtering the Bids 312 and Asks 314 listings based on shipping dates. The shipping date ranges are specified by the user in a From edit/list box 336 and a To edit/list box 338. In addition, the Current Trading Board view 310 includes a View Trading button 340, a View Graph button 342, and a Post Ask button 344. The View Graph button 342 allows a user to view a Graph screen (FIG. 10) as will be described in more detail below. The Post Ask button 344 is described below with reference to FIGS. 5(a) and 5(b). If the user is logged into the system 10 as a buyer, then the Post Ask button 344 is presented as a Post Bid button which accesses Post Bid 1 (FIG. 6(a)) and Post Bid 2(FIG. 6(b)) screens as described below.

To accept a “bid” or an “ask” (depending on whether the user is logged in as a “buyer” or as a “seller”, the user clicks on the price under the Zone price column 322 or the Delivered price 324, or the Zone price column 330 for an Ask in the static HTML Trading Board screen 300 (FIG. 3). In response, the system 10 displays a Transaction Summary screen 400 as shown in FIG. 4(a).

Referring to FIG. 4(a), the Transaction Summary screen 400 includes the GUI overlay or template 101, the active view window 102, the Trading Boards panel 103, and the My Desk panel 104 as described above. In response to the user clicking one of the HTML price objects appearing in the Current Trading Board view 310 (FIG. 3), the system 10 returns an Accept Posting view 410 for the product 212 being offered at the price selected by the user. The Accept Posting view 410 allows the user to enter a PO (Purchase Order) number or a default pieces per bundle number, depending on whether a “buy” or a “sell” transaction is being performed. The transaction is completed by the user indicating acceptance as will be described in more detail.

As shown in FIG. 4(a), if a sell transaction is being completed, the Accept Posting view 410 includes a Pcs/Bundle object 412 which takes the form of an edit box object. The seller enters the pieces of lumber per bundle for sell offer. If a buy transaction is being completed, then the Accept Posting view 410 presents a Purchase Order object in place of the Pcs/Bundle object 412, also in the form of an edit box object for the user to enter their purchase order number for the transaction. As shown the Accept Posting view 410 displays provides a number of information fields associated with the transaction. These information fields include Zone 418, Product type 420, Transportation Mode 422, Expected Volume 424, Expected Tally 426, Zone Price/mFBM 428, Delivery Price/mFBM 430, Total Price 432, Shipping Date 434, Date Constraint 436, and Ship From address 438. If the user decides not to complete the transaction, then a Return button 414 is selected and the system 10 returns the user to the Static HTML Trading Board screen 300 (FIG. 3). To complete the transaction, the user clicks an Accept button 416, and in response the system 10 displays a Transaction Confirmation screen 450 as shown in FIG. 4(b).

Referring to FIG. 4(b), the Transaction Confirmation screen 450 includes the GUI overlay or template 101, the active view window 102, the Trading Boards panel 103, and the My Desk panel 104 as described above. In response to the user clicking the Accept button 416 (FIG. 4(a)), the system 10 displays a Transaction Summary view 460 which summaries the information associated with the transaction.

Referring back to FIG. 3 and the static HTML Trading Board screen 300 includes a Post Ask button 344 if the user is logged in the system 10 as a seller. If the user is logged in the system 10 as a buyer, then the Post Ask button is replaced with a Post Bid button 344 in the HTML Trading Board screen 300. If the user is logged in as a seller, then clicking the Post Ask button 344 (FIG. 3) causes the system 10 to display a Post Ask 1 screen 500 as shown in FIG. 5(a).

Referring to FIG. 5(a), the Post Ask 1 screen 500 includes the GUI overlay or template 101, the active view window 102, the Trading Boards panel 103, and the My Desk panel 104 as described above, in addition to a Post Ask—Step 1 of 2 active view 510. The Post Ask view 510 presents the first of two steps for posting an ask by a seller (or a bid by a buyer). To this end, the Post Ask—Step 1 of 2 view 510 presents a number of objects which include a Ship Date edit/list box 512, a Date Constraint edit/list box 514, a Date Constraint edit/list box 514, a Mode edit/list box 516, a Calculated FBM (i.e. Foot-Board-Measure) Volume edit box 518, a Pcs/Bundle edit box 520, an Expected Tally edit box 522, and an Expire Time object comprising a Hours edit box 524 and a Minutes edit box 525. The Ship Date box 512 defines the desired week of shipping. The Date constraint list box 514 defines the ship date as: ‘Or Sooner’ or ‘Not Before’. The Mode list box 516 defines and sets the mode of transportation, e.g. “Rail Car”. The user selects the transportation mode displayed in the drop-down list box 516 which is maintained from the database 20 at the web site 12. The Calculated FBM Volume edit box 518 defines the mode volume which is recalculated using the default value specified in the Pcs/Bundle box 520. The Pcs/Bundle box 520 defines a default value which can be overwritten by the user. The default values for the Pcs/Bundle box 520 are maintained in a table by the application program. The Expected Tally edit box 522 defines the tally which is calculated automatically by the application program. The Hours 524 and Minutes 525 edit boxes define the length of time in hours and minutes the user wishes the posting to stay as active.

As shown in FIG. 5(a), the Post Ask—Step 1 of 2 active view 510 includes a Post Ask button 526 and a Cancel button 528. If the user clicks the Cancel button 528, the system 10 discards all of the information entered by the user and nothing is posted to the trading board. On the other hand, if the user clicks the Post Ask button 526 after having entered information in all of the required fields 512 to 525, the system 10 responds by displaying a Post Ask 2 screen 550 as shown in FIG. 5(b).

Reference is next made to FIG. 5(b) which shows the Post Ask 2 screen 550. The Post Ask 2 screen 550 includes the GUI overlay or template 101, the active view window 102, the Trading Boards panel 103, and the My Desk panel 104 as described above, and comprises a Post Ask—Step 2 of 2 active view 560. The Post Ask view 550 presents a Listing 552 of all the trading zones 554, shown individually as 554a, 554b, 554c and 554d, available for posting the lumber product. The Post Ask view 550 also includes a Post Ask button 556 and a Cancel button 558. As shown each of the trading zone listings 554 includes a respective New Ask edit box 560. The user enters a price value in the New Ask box 560 for the desired trading zone or zones, and then selects the Post Ask button 556. In response to the user clicking the Post Ask button 556, the system 10 accepts the posting and displays a Post Ask Confirmation screen as shown in FIG. 5(c). If the user clicks the Cancel button 558, the system 10 discards all of the information entered by the user and nothing is posted to the trading board.

The process for posting a bid is virtually the same as the process for posting an ask as described above with reference to FIGS. 5(a) to 5(c). If the user is logged in as a buyer, then clicking the Post Bid button 344 in the HTML Trading Board screen 300 (FIG. 3) causes the system 10 to display a Post Bid 1 screen 600 as shown in FIG. 6(a). The Post Bid 1 screen 600 as shown in FIG. 6(a) is virtually identical to the Post Ask 1 screen 500 (FIG. 5(a)) with the exception of the Pcs/Bundle object 520 being replaced by a Purchase Order # edit box 602. The Post Bid 1 screen 600 also includes Include Suppliers with Rating boxes 604 to 610. The Include Suppliers with Rating boxes 604 to 610 allow a user to define suppliers with designated ratings to be included for accepting the posted bid. The Post Bid 1 screen 600 also includes a Post Bid button 612 and a Cancel button 614. Clicking the Post Bid button 612 causes the system 10 to display a Post Bid 2 screen 650 as shown in FIG. 6(b). The Post Bid 2 screen 650 is virtually the same as the Post Ask 2 screen 550 (FIG. 5(b)) and includes a Post Bid button 652 which causes a Post Bid Confirmation screen 670 as shown in FIG. 6(c) to be displayed.

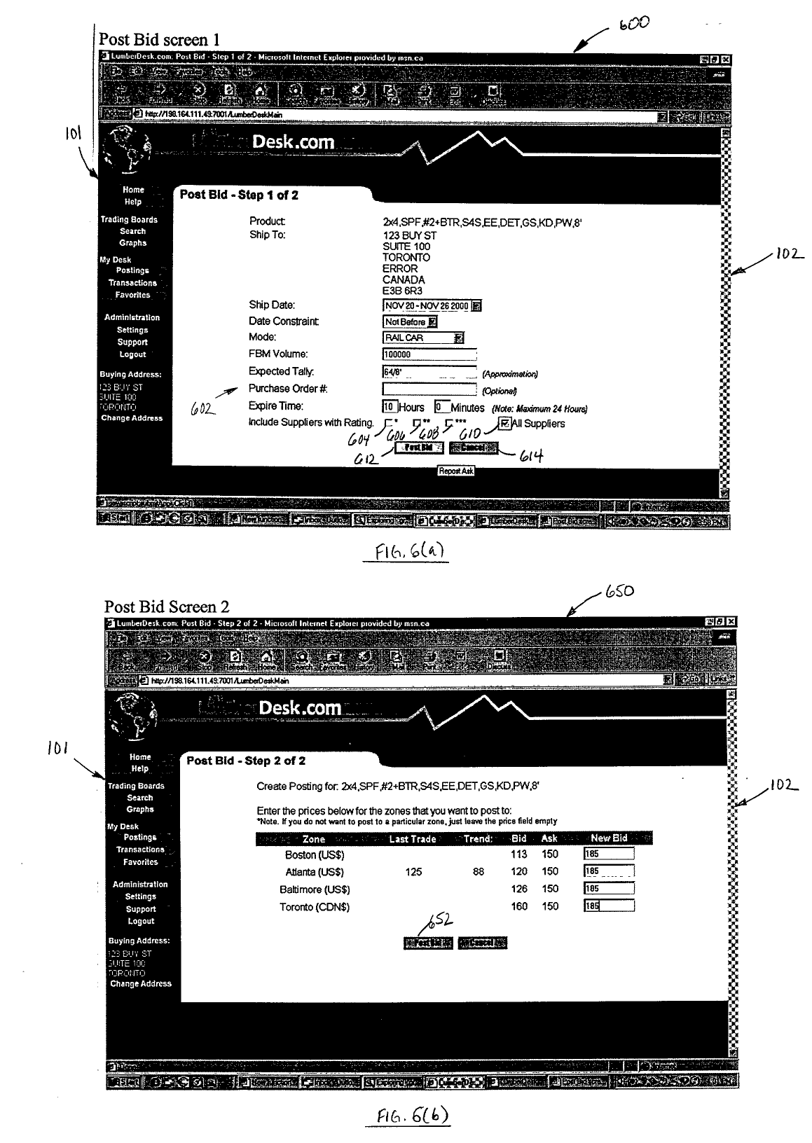

Reference is made back to FIG. 3 and the HTML Trading Board screen 300. As shown in FIG. 3, the HTML Trading Board screen 300 includes the View Trading button 340. Clicking the View Trading button 340 causes the system 10 to display a Real Time Trading Board views screen 700 as shown in FIG. 7. The Real Time Trading Board screen 700 is implemented in JAVA™ as an applet. Utilizing JAVA™ applets provides the capability for streaming data from the web server 16, which allows for real-time updates to the user computers 14 of the trade postings and information. The JAVA™ applet for the Real Time Trading Board views screen 700 allows users to see the real time updating of bids and asks.

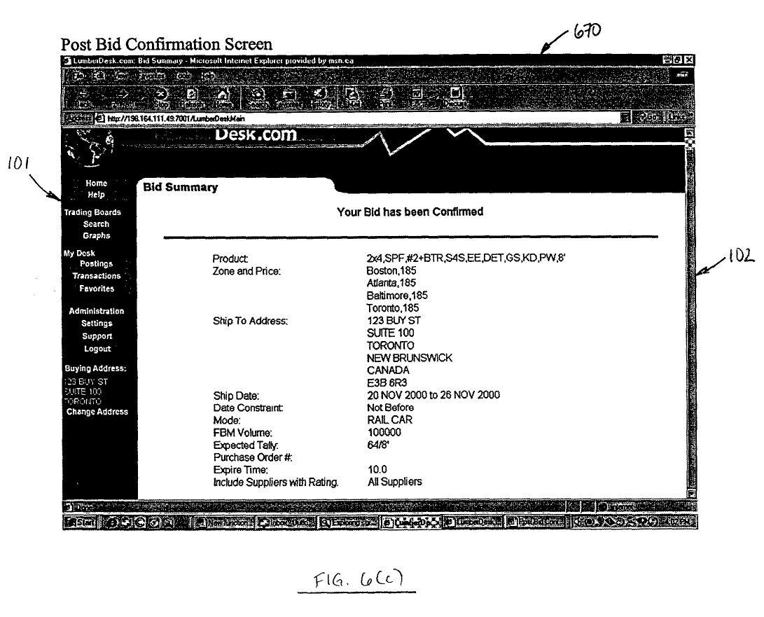

As described above, the My Desk panel 106 includes the Postings button 112, the Transactions button 114, and the Favorites button 116. The My Desk panel 106 is part of the GUI overlay 101 which appears in the screens with the exception of the Real Time Trading Board screen 700 (FIG. 7). Clicking the Postings button 112 causes the system 10 to display a Postings screen 800 as shown in FIG. 8.

Referring to FIG. 8, the Postings screen 800 includes the GUI overlay or template 101, the active view window 102, the Trading Boards panel 103, and the My Desk panel 104 as described above, in addition to a Postings view 810. The Postings view 810 displays all the posted bids/asks as zone postings 812, shown individually as 812a for the zone for Boston, 812b for the zone for Atlanta, and 812c for the zone for Toronto in FIG. 8. As shown in FIG. 8, the individual postings 813 for the Boston zone postings 812a are highlighted. The highlighted postings, for example 813a to 813c, represent the “true volume” of postings, as a bid or ask can be posted on more than one trading board, i.e. zone. For example, the posting 813c for a 27000 FBM truckload also appears as a posting 815c in the Atlanta zone 812b and as a posting 817b in the Toronto zone 812c. If a user accepts one of the postings, for example the posting 817b in the Toronto zone 812c, then the system 10 instantaneously removes the postings 813c and 815c.

As shown in FIG. 8, the Postings view 810 also includes a Hold button 814, an Activate button 816, a View button 818, an Edit button 820, a Delete button 822, Quick Adjust edit/list boxes 824 and 825, and a Modify Price button 826.

The Hold button 814 allows a user to place posting(s) on hold. As shown in FIG. 8, each posting includes a Check box 828, shown individually as 828a to 828h. To put a posting on hold, the user selects the Check box 828 associated with the posting, for example the Check box 828a for the posting 813a, and then the user clicks the Hold button 814. The user uses the Activate button 816 to make postings with an “on hold” status active. The user selects the corresponding Check box 828 for the posting on hold and clicks the Activate button 816.

The View button 818 allows a user to view the details of a selected posting. To view a posting, the user selects the Check box 828 next to the desired posting. The user then clicks the View button 818, and the system 10 displays a screen which shows the details of the posting.

The Edit button 820 allows a user to edit the details of a selected posting. To edit a posting, the user selects the Check box 828 next to the desired posting. The user then clicks the Edit button 820, and the system 10 displays a Modify Posting 1 screen 900 as shown in FIG. 9(a) which shows the details of the posting.

Referring to FIG. 9(a), the Modify Posting 1 screen 900 includes the GUI overlay or template 101, the active view window 102, the Trading Boards panel 103, and the My Desk panel 104 as described above, in addition to a Modify Ask—Step 1 of 2 active view 910. The Modify Ask view 910 is identical to the Post Ask 500 and the Post Bid 600 screens described above. Users have the same options available to them as if they were posting a bid/ask for the first time. Required fields such a Ship Date 912, Date Constraint 914, Mode 916, FBM Volume 918, Expected Tally 920, Pieces per Bundle 922 and Expire Time 924 may be modified or simply viewed. Once the user is finished making changes, the user clicks a Post Ask button 926 which causes the system 10 to display a Modify Posting 2 screen 950 as shown in FIG. 9(b).

Referring to FIG. 9(b), the Modify Posting 2 screen 950 includes the GUI overlay or template 101, the active view window 102, the Trading Boards panel 103, and the My Desk panel 104 as described above, in addition to a Modify Ask—Step 2 of 2 active view 960. The Modify Ask—Step 2 of 2 view 960 functions the same as the Post Ask 2 screen 550 described above with reference to FIG. 5(b).

Referring back to FIG. 8, the Delete button 822 allows a user to delete any posting that has its corresponding Check box 828 selected. Clicking the Delete button 822 causes the system 10 to delete and pull any records of the selected posting from the trading boards.

The Modify price button 826 allows a user to increase or decrease the price of the selected postings. The Quick Adjust list box 824 is set to either “Increase” or “Decrease” and the dollar amount is entered in the Modify Price edit box 825. Postings must have their corresponding Check box 828 selected for their price to be modified. The user then clicks the Modify price button 826, and the postings on hold are modified by the amount that was entered in the Modify Price edit box 825.

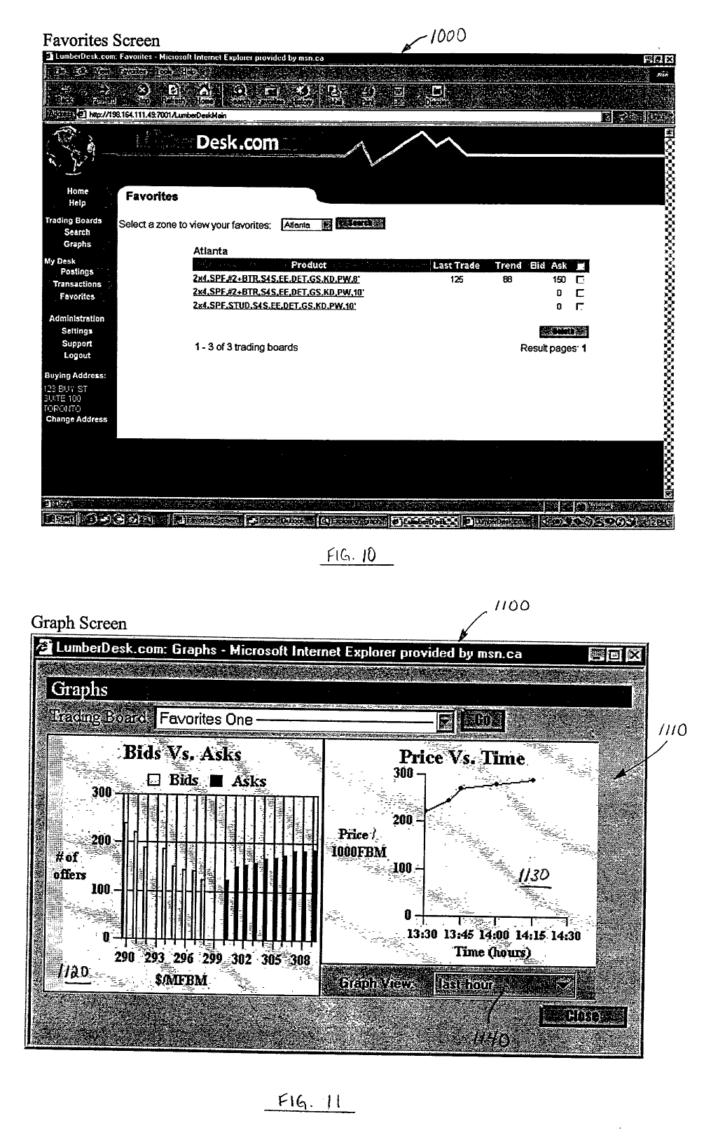

Clicking the Graphs button 110 in the GUI overlay 101 causes the system 10 to display a Graph screen 1100 as shown in FIG. 11. The Graph screen 1100 comprises an active view window 1110 which displays a “Bids vs. Asks” graph 1120 and a transaction “Price vs. Time” graph 1130. Both graphs 1120 and 1130 are preferably implemented as JAVA™ applets to allow real-time updates of data from the database 20 in the web site 12. The data displayed in the graphs 1120 and 1130 is in relation to the HTML Trading Board screen 300 from which the Graph button 110 was activated.

As shown in FIG. 11, the JAVA™ applet for Bids vs. Asks graph 1120 provides a dynamic bar graph of the system generated zone bids versus the posted zone asks. The number of offers is mapped to the y-axis and the price per offer is mapped to the x-axis. The JAVA™ applet for the Price vs. Time graph 1130 displays a line graph of the transaction price (mapped to the y-axis) over time (mapped to the x-axis). As shown, the Price vs. Time graph 1130 includes a Time button 1140, which allows a user to define the time period over which the price data is compiled.

As described above, the system 10 permits an offer to be posted on multiple trading boards, that is, multiple zones as each trading board is referenced to a zone. The offer can be priced differently on two or more trading boards. When an item posted on multiple boards is sold, the system 10 removes the item from al the other boards, for example, through the use of JAVA™ applets. Preferably, the system 10 also includes a mechanism to prevent an offer posted on multiple trading boards from being sold more than once.

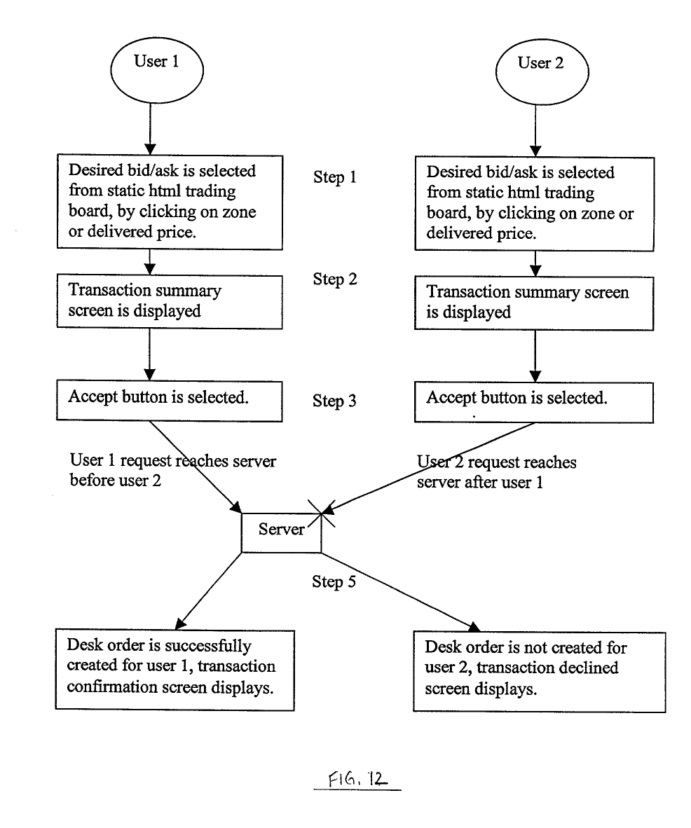

The steps for completing a transaction utilizing the real-time commodity trading system 10 according to the present invention may be summarized according to the following steps with reference to FIG. 12:

| | |
|---|---|
| (Step 1) | A user selects the desired bid/ask from the static HTML Trading |
| | Board screen 300 (FIG. 3) by clicking on the Zone price 320 |
| | (FIG. 3) or the Delivered price 322 (FIG. 3). |
| (Step 2) | The system 10 displays the Transaction Summary screen 400 |
| | (FIG. 4(a)). |
| (Step 3) | The user then clicks the Accept button 416 in the Transaction |
| | Summary screen 400 (FIG. 4(a)). To abort the transaction, the |
| | user clicks the Return button 414 (FIG. 4(a)). |
| (Step 4) | The application program for User 1 sends the transaction |
| | summary information (e.g. via the Internet) to the web site 12 |
| | and a desk order 26 is created an stored in memory (e.g. disk |
| | memory 28) on the web server 16. The web server 16 transmits |
| | (i.e. downloads) the Transaction Confirmation screen 450 |
| | (FIG. 4(b)). The Transaction Confirmation screen 450 |
| | includes an object 462 to show the ‘Shipping from’ |
| | address information and an object 464 to show the ‘Shipping |
| | to’ address information for the confirmed transaction. |

It is contemplated that there will be a situation in which two users connected to the system 10 perform the above steps to accept a ‘bid/ask’ on the same posted ‘bid/ask’ up to step (3) above. This means that after simultaneously clicking the Accept buttons 416 (FIG. 4(a)) on their respective user stations 14, the submit messages from both users will be on their way to the web server 16. In such a situation, the web server 16 confirms the transaction for the user whose submit message reaches the server 16 first and a desk order 26 is created, as described above for step (4). For the other user, the submit message is declined and a message is transmitted to the user's computer 14 indicated the unsuccessful transaction. Steps (1) to (4) and the race condition between two users are summarized in flow chart form in FIG. 12.

It will be understood that the real-time commodity trading system 10 concludes transactions on the basis of delivered prices. To prevent any supplier from gaining an advantage, trading board pricing is based on the commodity product delivered to the zone for the that trading board regardless of the origin of the supplier, and the suppliers bid on a trading board zone with transportation costs included in their prices. However, buyers are not interested in delivered prices to the trading zone (unless of course the buyer is located in the geographic center of the trading zone). Buyers are interested in the delivered price to their address destinations. Therefore to protect competing suppliers from being distinguished by buyers on the basis of differences in their freight charges, the system 10 includes a freight rate adder mechanism to account for the differences between ‘trading zone’ and ‘delivered’ prices.

As described above, the web server 16 (FIG. 1) includes a regional transportation rate database 21 which stores freight rates on an origins to destinations basis. The regional transportation rate database 21 is organized into Trading Zones 30, Supplier Regions 31, and Customer Regions 32. The Supplier Regions 31 are defined in terms of arbitrary geographic areas which represent a concentration of suppliers. As described above, the primary purpose for defining the Supplier Regions 31 is to protect competing suppliers from being distinguished by potential buyers based on differences in their delivered freight charges. The Customer Regions 32 are defined as arbitrary geographic areas which represent a customer locale. The Trading zones 30 are defined for the active trading board zones and comprise arbitrary geographic centers of market activity for commodity being traded. The geographic center of each of the defined regions 30, 31, 32 is used for freight rate calculations.

As described above in the context of the real-time commodity trading system 10, there are two types of users, buyers and sellers, who complete transactions. The buyers post their ‘bids’ with a delivered price to their address, i.e. buyers buy “Free on Board” or FOB. The sellers, on the other hand, post their ‘asks’ (i.e. offers to sell ) with a delivered price to a predefined geographic area or zone, i.e. sellers sell FOB delivered. As shown in the HTML Trading Board screen 300 (FIG. 3), both delivered prices and zone prices are displayed respectively for both the bid (i.e. buyers) and the ask (i.e. sellers) listings of the screen 300.

In accordance with this aspect of the invention, freight adders are used to calculate and display the differences between the trading zone (i.e. seller) price and the delivered (i.e. buyer) price. The shipping origins of the commodities are described in terms of mill zones which are defined as a group of production mills in the same geographic area and stored in the database 21 under the Supplier Regions 31. For the shipping destinations, there are two types of destinations: a buyer's address destination, and a trading zone destination. The buyer's address destination is the ‘ship to’ address for the order. In the database 21, the buyer's address destinations are stored under the Customer Regions 33. The trading zone destination is defined as a reference point in the trading zone which is used by the system 10 to price the commodities for both buyers and sellers. The trading zone destinations are stored in the database 21 under the Trading Zones 30.

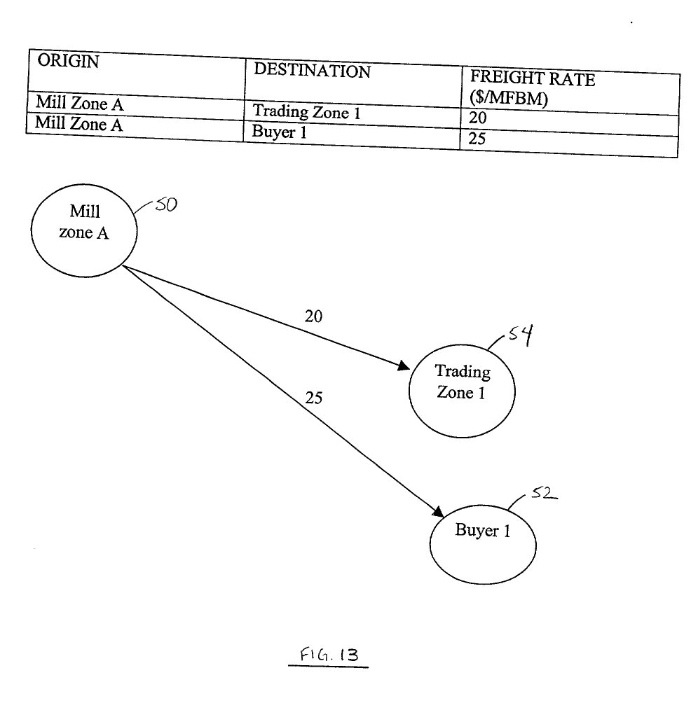

For the example as shown in FIG. 13, the origin destination is defined as Mill Zone A (indicated by reference 50 ), and the buyer destination is defined for buyer 1 (indicated by reference 52), and the zone destination is defined for Trading Zone 1 (indicated by reference 54 ).

In this example, if a seller located at Mill Zone A posts an ‘ask’ (i.e. offer to sell ) at a price of $350 delivered to Trading Zone 1, then the posted ask will have a value of $330 at Mill Zone A (i.e. the shipment originates from Mill Zone A and the freight rate between Mill Zone A and Trading Zone 1 is $20/mFBM for the seller). For the buyer, the posted bid has a delivered price of $355 which is based on the freight rate of $25/mFBM between Mill Zone A and the buyer's destination. Therefore the freight rate adder for the buyer is $5/mFBM, which represents the additional freight cost for shipping to the buyer's address when compared to the freight cost for shipping to the defined Trading Zone 1. On the other side, if the buyer posts a ‘bid’ (i.e. offer to buy) price of $300 delivered, then based on the freight rate adder mechanism, the posted bid will have a value of $275/mFBM at Mill Zone 1 (i.e. $300/mFBM−$25/mFBM) and a value of $295/MFBM at Trading Zone 1 (i.e. $275/mFBM+$20/mFBM).

For a buyer viewing an HTML Trading board (for example as shown in FIG. 3): on the “BIDS” listing 312 the buyer will see a trading zone price of $295/mFBM under the Zone price column 320 and a delivered price of $300/mFBM under the Delivered price column 322. The trading zone price is based on the freight adder rate as described above, while the delivered price is that posted by the buyer. On the “ASKS” listing 314, the buyer will see a trading zone price of $350/mFBM posted by the seller under the Zone price column 330. The trading zone price is that posted by the seller, while the delivered price is calculated according to the freight rate adder mechanism described above.

For a seller viewing an HTML Trading Board (for example as shown in FIG. 3): on the “BIDS” listing 312, the seller sees a trading zone price of $295/mFBM under the Zone price column 320 and a delivered price of $300/mFBM under the Delivered price column 322. The trading zone price is based on the freight adder rate to ship from the address of the seller, and the delivered price is that posted by the buyer. On the “ASKS” listing 314, the seller sees a trading zone price of $350/mFBM posted by the seller under the Zone price column 330, as posted by the seller.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A network-based system for trading physical commodities in real-time, said system comprising:
(a) a server coupled to a network;
(b) said network including a plurality of ports for coupling user stations to said network for communicating with said server;
(c) said server including a component for generating a trading board, said trading board comprising posted offers for a physical commodity and said trading board being referenced to a trading zone, wherein said trading zone comprises a geographic area having one or more suppliers of the physical commodity and one or more potential buyers of said physical commodity, and said server including a component for sending said trading board to one or more of said user stations coupled to said network;
(d) said user stations including a display component for displaying said trading boards, and further including a component for accepting a posted offer on said trading board and communicating said acceptance to said server.

2. The network-based system as claimed in claim 1, wherein said user stations include a component for posting bids for the physical commodity on said trading board.

3. The network-based system as claimed in claim 2, further including a freight rate mechanism, said freight rate mechanism including a component for adjusting a posted offer on a delivered basis for buyers, and a component for adjusting the posted bid on a delivered to trading zone basis for suppliers.

4. The network-based system as claimed in claim 3, wherein said network comprises the Internet and World Wide Web.

5. The network-based system as claimed in claim 2, wherein said server includes a database for storing information related to said posted offers and said posted bids, and wherein said trading board displayed on said user stations includes an update component for accessing and receiving said information from said database over said network and displaying said information at the user stations.

6. The network-based system as claimed in claim 5, wherein said trading board includes a graph component, said graph component including a graphical view selectively displayable on said user station, and said graph component including a component for receiving current information from said database for updating said graphical view.

7. The network-based system as claimed in claim 6, wherein said graphical view comprises a graphical mapping of transaction prices for the physical commodity over time.

8. The network-based system as claimed in claim 6, wherein said graphical view comprises a graphical mapping of the number of posted offers and posted bids versus price per offer and bid.

9. The network-based system as claimed in claim 3, wherein said server includes a regional transportation database for storing a plurality of supplier regions, a plurality of buyer regions, and a plurality of said trading zones, and each of said supplier and said buyer regions and said trading zones having a defined geographic center for use by said freight rate mechanism.

10. A network-based system for trading physical commodities in real-time, said system comprising:
(a) a server coupled to a network;
(b) said network including a plurality of ports for coupling user stations to said network for communicating with said server;
(c) said server including a component for generating a trading board, said trading board comprising posted offers for a physical commodity and said trading board being referenced to a trading zone, wherein said trading zone comprises a geographic area having one or more suppliers of the physical commodity and one or more potential buyers of said physical commodity, and said server including a component for sending said trading board to one or more of said user stations coupled to said network;
(d) said user stations including a component for posting a bid for a physical commodity being offered on said trading board;
(e) said user stations including a display component for displaying said trading boards, and further including a component for accepting a posted offer on said trading board and communicating said acceptance to said server.

11. The network-based system as claimed in claim 10, wherein said component for posting bids includes a component for posting said bid on a plurality of trading boards.

12. The network-based system as claimed in claim 10, wherein said component for posting a bid further includes a component for rating potential suppliers responding to said posted bid.

13. The network-based system as claimed in claim 11 or 12, wherein said component for posting a bid further includes a component for setting a time duration said posted bid remains open.

14. The network-based system as claimed in claim 12, wherein said component for posting a bid further includes a component for specifying a future delivery date for the physical commodity associated with said posted bid.

15. The network-based system as claimed in claim 11, wherein said component for posting bids includes a component for modifying said bid posted to a plurality of trading boards.

16. The network-based system as claimed in claim 10, wherein said server includes a component for generating a plurality of trading boards, and a component for removing a posted offer which has been accepted from all of said trading boards on which said posted offer appeared.

17. The network-based system as claimed in claim 10, further including a freight rate mechanism, said freight rate mechanism including a component for adjusting a posted offer on a delivered basis for buyers, and a component for adjusting the posted bid on a delivered to trading zone basis for suppliers, and said freight rate mechanism comprising a regional transportation database for storing a plurality of supplier regions, a plurality of buyer regions, and a plurality of said trading zones, and each of said supplier and said buyer regions and said trading zones having a defined geographic center for use by said freight rate mechanism.

18. A computer data signal embodied in a carrier wave, said carrier wave comprising:
(a) a trading board view code segment; and
(b) said trading board view code segment comprising a plurality of posted offer code segments and plurality of posted bid code segments and a trade zone code segment, said trading board view segment defining a trading board view referenced a trading zone defined by said trade zone code segment, and wherein said trading zone corresponds to a geographic area.
